(19) United States
(12) Patent Application Publication
(10) Pub. No.: US 2025/0231821 A1
(43) Pub. Date: Jul. 17, 2025

(54) REAL TIME UPDATES OF MULTIPLE VIEWS OF A COMPUTER PROCESS FLOW

(71) Applicant: ServiceNow, Inc., Santa Clara, CA (US)

(72) Inventors: Jan Ove Kristian Olsson, Castro Valley, CA (US); Yaron Guez, San Diego, CA (US); Min Wu, Pleasanton, CA (US); Zhe Wang, San Francisco, CA (US); Grant Plaster, Escondido, CA (US)

(21) Appl. No.: 18/411,711

(22) Filed: Jan. 12, 2024

(51) Int. Cl. G06F 9/54; G06F 9/451

(52) U.S. Cl. CPC G06F 9/542; G06F 9/451

(57) ABSTRACT

An indication of a user interaction with a user interface element of a user interface is received, wherein the user interface enables generation of a computer process flow. A data change action associated with the user interaction is determined. The data change action is validated. Based on the data change action, a computer process flow state associated with the computer process flow is updated to reflect the data change action. In response to the computer process flow state being updated to reflect the data change action, one or more behaviors based on the data change action are triggered.

### BACKGROUND OF THE INVENTION

Workflow management may include identifying, categorizing, structuring, tracking, documenting, or optimizing various tasks and processes. In some circumstances, a workflow management system provides an infrastructure for the set-up, performance, and monitoring of a defined sequence of tasks.

Correctly applied, workflow management brings together clear visibility, process automation, and support tools to guide people and processes. Additionally, teams that operate within reliable workflows see greater productivity and efficiency, and are more goal-oriented than those who do not. However, some workflow management systems do not provide efficient or effective access to workflow data, and therefore these systems do not allow for effective visibility into the steps and processes involved and which roles are responsible for which actions.

### BRIEF DESCRIPTION OF THE DRAWINGS

Various embodiments of the invention are disclosed in the following detailed description and the accompanying drawings.

FIG. 1 illustrates an exemplary data flow 100 of the process automation designer.

FIG. 2 illustrates an exemplary process 200 for data flow 100, which includes user interaction layer 102, validation layer 104, computer process flow state layer 106, and computer process flow state changes handling layer 108.

FIG. 3 illustrates an exemplary user interaction layer 300.

FIG. 4 illustrates an exemplary validation layer 400.

FIG. 5 illustrates an exemplary computer process flow state changes handling layer 500.

FIG. 6 illustrates another exemplary validation layer 600.

FIG. 7 illustrates an exemplary validation process 700.

FIG. 8 illustrates an exemplary process 800 for executing the validators.

FIG. 9A illustrates that validation errors are populated in a board view 900.

FIG. 9B illustrates an example board view 950 with a number of validation errors.

FIG. 10A illustrates that the validation errors are populated in a diagram view 1000.

FIG. 10B illustrates an example diagram view 1050 with a number of validation errors.

FIG. 11A illustrates that the validation errors are populated in an error tray 1100.

FIG. 11B illustrates another example error tray 1150 with a number of validation errors.

FIG. 12 illustrates that the validation errors are populated in a side panel 1200.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The fundamental units of work are tasks, processes, and workflows. A task is the basic building block of all work. Tasks are performed by individuals, but they can vary dramatically in complexity and time required for completion. Tasks may be divided into two types: single step and multi-step. When tasks are grouped together to achieve a desired result or objective, they form a process. For example, when an employee needs help solving an information technology (IT) issue, the employee initiates a process made up of multiple tasks. Processes that become interdependent with other people or processes are called workflows. A workflow comprises the interdependent processes and people required to reach a result that no single participant can achieve alone.

For example, submitting a help-desk request to IT is one element of a larger workflow that ultimately resolves the issue. Processes contained in the IT department are set in motion by requests, leading to prioritization, assignment, and fulfillment. The span of activities from problem to solution, and every person involved, comprises a workflow. The help-desk ticket workflow example may include a number of processes. During the first process, the employee with the broken equipment submits and tracks a help ticket. During the second process, Help Staff prioritizes and investigates the help ticket. During the third process, a technician visits the employee to see the problem in person. A process may include multiple tasks. For example, during the third process, the visit from a technician involves assigning the problem, determining the employee's location, and confirming that it is a good time for a visit, etc.

A cloud-based workflow management and automation tool may be used to allow users to design, build, and manage automated processes and workflows. There are a number of benefits that can be gained by using such a system, including improved efficiency, improved accuracy, better visibility, improved customer service, and the like.

For example, a workflow management and automation tool may provide step-by-step guidance for resolving processes and enable agents to easily manage the lifecycle of cases by guiding them through sequences of tasks. The workflows that are associated with a specific type of case and the activities that need to be completed to resolve cases of this type are detailed in the tool. The tool may also include a graphical user interface (UI) that helps users to visualize the entire lifecycle of a workflow.

However, existing workflow management and automation tools have different limitations and inefficiencies. Traditional techniques do not have consistent ways for handling data flows through the workflow management and automation tool, updating the UIs, and storing persistent data to the database. The workflow management and automation tool may provide a number of different UIs/views, including a board view and a diagram view. For example, a visual task board or Kanban board view provides a visual representation of work items, organized into columns that represent different stages of the workflow. The board may be divided into swimlanes, which may represent different teams, projects, or work types. A diagram view or a process diagram provides a visual representation of the flow and dependencies within a process or system. When a user makes changes to a process in one view, the different views sharing the same data should be updated to reflect the changes made to the process. For example, when the user adds an activity to a process, both the board view and the diagram view should be updated. Each view may have different requirements. In other traditional techniques, after an operation is made in one view, the change of the data associated with the operation is stored in a database, and other views will need to re-fetch the information from the database in order to update all the views to reflect those changes. In other words, the database is used as the single source of truth. In a single source of truth (SSOT) architecture, information models and associated data schemas are structured such that every data element is mastered (or edited) in only one centralized location.

However, using the database as the single source of truth has a number of disadvantages. An operation (e.g., adding an activity or deleting an activity in a process) in a particular view may not always map directly onto a database operation. Each view may have a different way to translate an operation in that view to its corresponding database operations. As a result, an operation that is made in one view and then updated in another view will require multiple rounds of translations, thereby increasing the overall complexity and overhead in code development. In addition, using the database as the single source of truth is inefficient because the views are limited to interacting with the database in terms of database structures, including records, fields, and the like. In addition, re-fetching all the information from the database by each view after each operation is slow and inefficient because each view needs to wait for a round trip time for the request to be sent to the database and then the response from the database to be received by the view.

In the present application, improved techniques for a workflow management and automation tool are disclosed. An indication of a user interaction with a user interface element of a user interface used to build a computer process flow is received. A data change action associated with the user interaction is determined. The data change action is validated. Based on the data change action, a computer process flow state associated with the computer process flow is updated to reflect the data change action. In response to the computer process flow state being updated to reflect the data change action, one or more behaviors based on the data change action are triggered.

In the present application, a process automation designer (PAD) that gives the process authors a simple, interactive way to design digitized and automated processes is disclosed. The workflow management and automation tool may provide a number of different UIs/views, including a board view and a diagram view. For example, a visual task board or Kanban board view provides a visual representation of work items, organized into columns that represent different stages of the workflow. The board may be divided into swimlanes, which may represent different teams, projects, or work types. A diagram view or a process diagram provides a visual representation of the flow and dependencies within a process or system. The views may take a workflow process and break it into multiple stages or lanes. A lane is a channel in which activities are grouped. A lane represents one stage in a business process. A lane may be used to sequence process activities. A lane may include many sequenced activities that are grouped in a logical way. Typically, a lane is displayed on a board vertically, whereas a swimlane is displayed on a board horizontally. Each stage includes one or more activities, or steps, for an agent to complete. The terms “activities,” “steps,” and “tasks” are herein used interchangeably. Stages can also include automated activities, such as sending an email to a customer when a stage or activity is complete.

The process automation designer (PAD) includes a data manager that provides consistent ways for handling data flows through the workflow management and automation tool, updating the UIs, and storing persistent data to the database by creating a framework with lifecycle hooks. In the framework, components have lifecycles, representing different stages from creation to destruction. Lifecycle hooks provide specific points in the execution flow of a program or application where custom code may be executed. Developers may leverage the lifecycle hooks to perform actions at specific moments during a lifecycle. The framework provides a consistent client side experience in PAD and maintains a centralized computer process flow state/source of truth.

The data manager enables a clearer separation between data and UIs, which enables the building of a single PAD architecture with two distinct UIs (board and diagram views) on top of the same data and the merging of the board (kanban) UI and the diagram UI into one consistent experience. To ensure a consistent behavior whenever a change happens in PAD, any client side data change goes through a defined client side data flow. The central computer process flow state acts as the source of truth of the process on the client. Any views or components may update the source of truth via a defined operation interface provided by the client data manager. Any views or components may listen to and react to changes to the central client data state via a defined interface at the client data manager. This ensures that the client has a centralized consistent client data flow and clear owner of the computer process flow state, and the components or views may react after the changes have been made to the computer process flow state, for example, by updating the view, persisting to the server, or handling errors consistently, with clear separation of concerns.

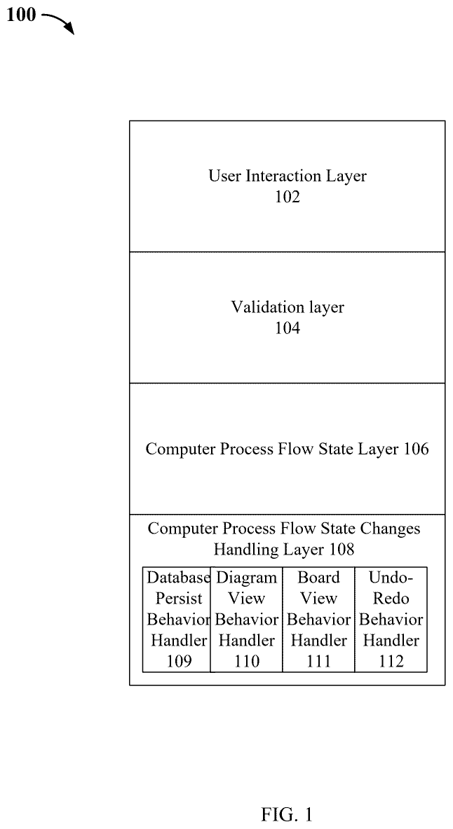

FIG. 1 illustrates an exemplary data flow 100 of the process automation designer. In some embodiments, data flow 100 may include a number of distinct layers, including a user interaction layer 102, a validation layer 104, a computer process flow state layer 106, and a computer process flow state changes handling layer 108. At user interaction layer 102, a user behavior may trigger different changes. For example, a user may add or delete an activity in a process, which triggers different data changes. At validation layer 104, the data changes are validated by a validation behavior module by running a set of validators. A validator may block the data flow or dispatch a notification while allowing the changes to go through. Once data has been validated, at computer process flow state layer 106, the changes are applied on the internal processData property by a process-state behavior module. A notification that the computer process flow state has been updated is provided. At computer process flow state changes handling layer 108 (also referred to as the client data manager), different behavior handlers may listen/subscribe to the notifications of any applicable changes. In response to a computer process flow state that has been updated, the different behavior handlers may react to any applicable changes. For example, the UIs may be updated to reflect those changes.

The behavior handlers may include a database persist behavior handler 109, a diagram view behavior handler 110, a board view behavior handler 111, and an undo-redo behavior handler 112. Database persist behavior handler 109 handles the persisting of any state changes that need to be saved to the server. Diagram view behavior handler 110 performs incremental updates to the diagram view for any state changes that may be applied to the diagram view, e.g., adding or updating an activity or a lane of the process. Board view behavior handler 111 updates the board view for any state changes that may be applied to the board view, e.g., adding or updating an activity or a lane of the process. Undo-redo behavior handler 112 tracks the changes/actions on the computer process flow state for undo/redo.

Data flow 100 of the process automation designer is used for the initial loading or the loading of a new process (i.e., switching to a new process). In some embodiments, switching to a new process includes removing all the activities and lanes from the previous process in the computer process flow state. In some embodiments, the initial loading of a process includes setting a special persistData=False flag to ensure that the data is not persisted again to the server.

The improved framework and techniques have many benefits. The framework clearly separates and defines ownerships within the framework. Unlike other traditional techniques, the UIs do not need to calculate the business logic. The framework also enables parallel processing, e.g., updating the UIs immediately and persisting the data to the server in parallel in the background, leading to a much better user experience. It also easily enables features such as undo/redo to hook into the data flow to enable new features almost automatically.

The framework provides a consistent experience when a user creates and edits processes in PAD. The data manager provides a consistent way to handle how the user changes flow through the system and how the user changes are updated. It enables instant UI changes across any views (board and diagram views). It enables automatic persistence on the server in the background. It enables real time validation. It enables automatic undo/redo support for any changes. In addition, it enables consistent UI updates across different views (board vs diagram) on the same data. Ater each operation, synchronization of the operation is done in memory. There is no need for each view to refetch all the information from the database, thereby eliminating the need for each view to wait for a round trip time for the request to be sent to the database and then the response from the database to be received by the view.

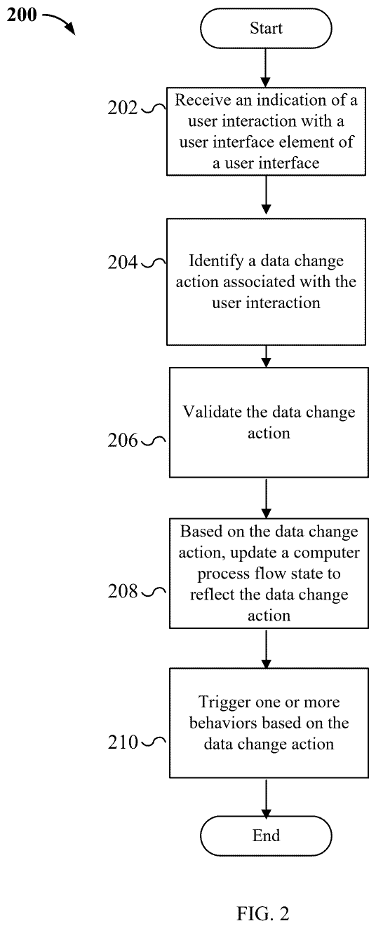

FIG. 2 illustrates an exemplary process 200 for data flow 100, which includes user interaction layer 102, validation layer 104, computer process flow state layer 106, and computer process flow state changes handling layer 108.

At step 202, an indication of a user interaction with a user interface element of a user interface used to build a computer process flow is received. At step 204, a data change action associated with the user interaction is identified.

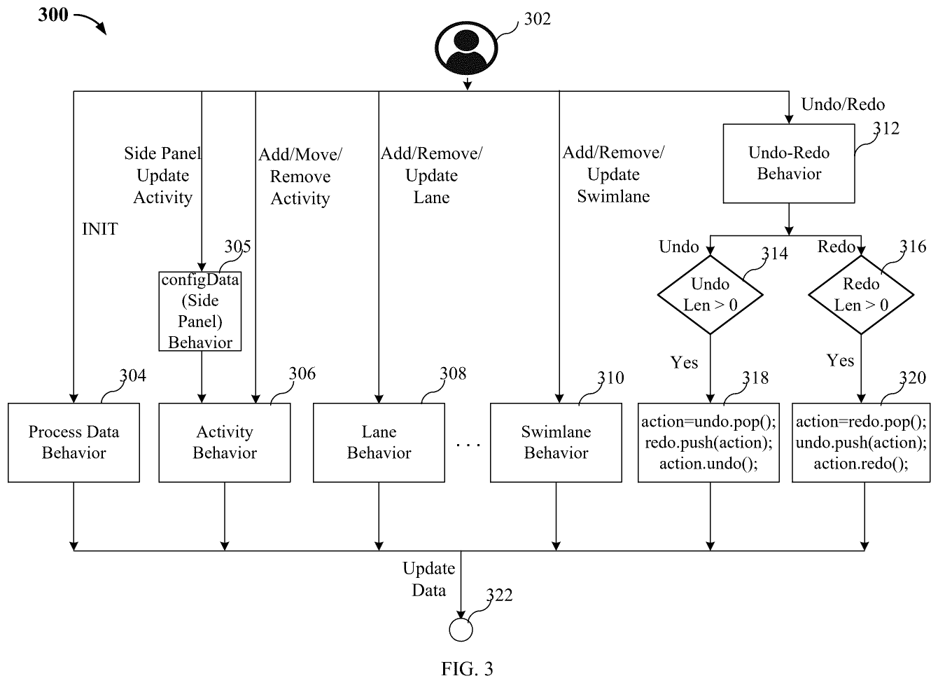

FIG. 3 illustrates an exemplary user interaction layer 300. In some embodiments, user interaction layer 300 is at least a part of user interaction layer 102 in FIG. 1, and user interaction layer 300 may be used to perform at least part of steps 202 and 204 of FIG. 2.

As illustrated, user interaction layer 300 includes a plurality of modules for handling different types of user interactions, including a process data behavior module 304, an activity behavior module 306, a lane behavior module 308, a swimlane behavior module 310, and an undo-redo behavior module 312. However, user interaction layer 300 is not limited to the modules as shown, and additional modules may be added to user interaction layer 300 for other types of user interactions with other user interface elements of other user interfaces.

In one example, a user 302 may update an activity in a process. The update may include adding, moving, or removing the activity from one of the UIs. An indication of the user interaction (i.e., adding, moving, or removing) with a user interface element (i.e., an activity) of a user interface (e.g., a board view, a diagram view, or a side panel) is received. For example, if user 302 updates the activity via the board view or the diagram view, activity behavior module 306 receives the indication of the user interaction and determines the data change action associated with the user interaction, which is sent to an output 322 of user interaction layer 300. If user 302 updates the activity via a side panel view, an indication of the user interaction is sent to a configData behavior module 305 and then sent to activity behavior module 306, and the data change action/updated data associated with the user interaction is determined, which is sent to output 322 of user interaction layer 300.

In another example, an initialization is received from user 302 via a user interface element of one of the user interfaces. The indication of the user interaction is received by process data behavior module 304 and the data change action/updated data associated with the user interaction is determined, which is sent to output 322 of user interaction layer 300.

In another example, user 302 may configure a lane. The configuration may include adding, removing, or updating the lane from one of the UIs. An indication of the user interaction (i.e., adding, removing, or updating) with a user interface element (i.e., the lane) of a user interface (e.g., a board view or a diagram view) is received. For example, if user 302 configures the lane via the board view or the diagram view, then lane behavior module 308 receives the indication of the user interaction and determines the data change action/updated data associated with the user interaction, which is sent to output 322 of user interaction layer 300.

In yet another example, user 302 may configure a swimlane. The configuration may include adding, removing, or updating the swimlane from one of the UIs. An indication of the user interaction (i.e., adding, removing, or updating) with a user interface element (i.e., the swimlane) of a user interface (e.g., a board view or a diagram view) is received. For example, if user 302 configures the swimlane via the board view or the diagram view, then swimlane behavior module 310 receives the indication of the user interaction and determines the data change action/updated data associated with the user interaction, which is sent to output 322 of user interaction layer 300.

In yet another example, user 302 may undo or redo a previous user interaction with a user interface element of one of the user interfaces. For example, one or more of the UIs may include “undo” or “redo” buttons as user interface elements. If user 302 clicks the undo button via the board view or the diagram view, then undo-redo behavior module 312 receives the indication, and if (Undo Len>0) at 314, then module 318 performs a plurality of steps and determines the data change action, which is sent to output 322 of user interaction layer 300. If user 302 clicks the redo button via the board view or the diagram view, then undo-redo behavior module 312 receives the indication, and if (Redo Len>0) at 316, then module 320 performs a plurality of steps and determines the data change action/updated data, which is sent to output 322 of user interaction layer 300.

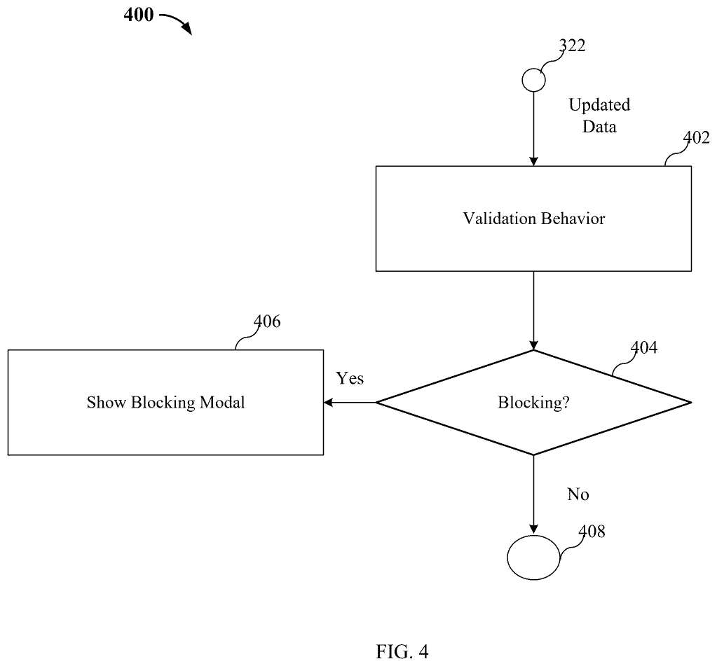

Referring back to process 200 in FIG. 2, at step 206, the data change action is validated. FIG. 4 illustrates an exemplary validation layer 400. In some embodiments, validation layer 400 is at least a part of validation layer 104 in FIG. 1, and validation layer 400 may be used to perform at least part of step 206 of FIG. 2.

At validation layer 400, the data change actions/updated data received from output 322 of user interaction layer 300 are validated by a validation behavior module 402 by running a set of validators. A validator may determine whether the data change action should be blocked. At 404, if the data change action should be blocked, then a blocking modal is shown at 406. If the data change action should not be blocked, then a notification may be provided and the data change actions are allowed to pass through as an output at 408.

Referring back to process 200 in FIG. 2, at step 208, based on the data change action, a computer process flow state associated with the computer process flow is updated to reflect the data change action. In some embodiments, computer process flow state layer 106 may be used to perform at least part of step 208 of FIG. 2. A process-state behavior module is used to perform the data change action and update a computer process flow state that is associated with the computer process. The computer process flow state is updated to reflect the data change action. The process-state behavior module maintains a centralized computer process flow state that acts as the source of truth of the process on the client.

At step 210, in response to the computer process flow state being updated to reflect the data change action, one or more behaviors based on the data change action are triggered.

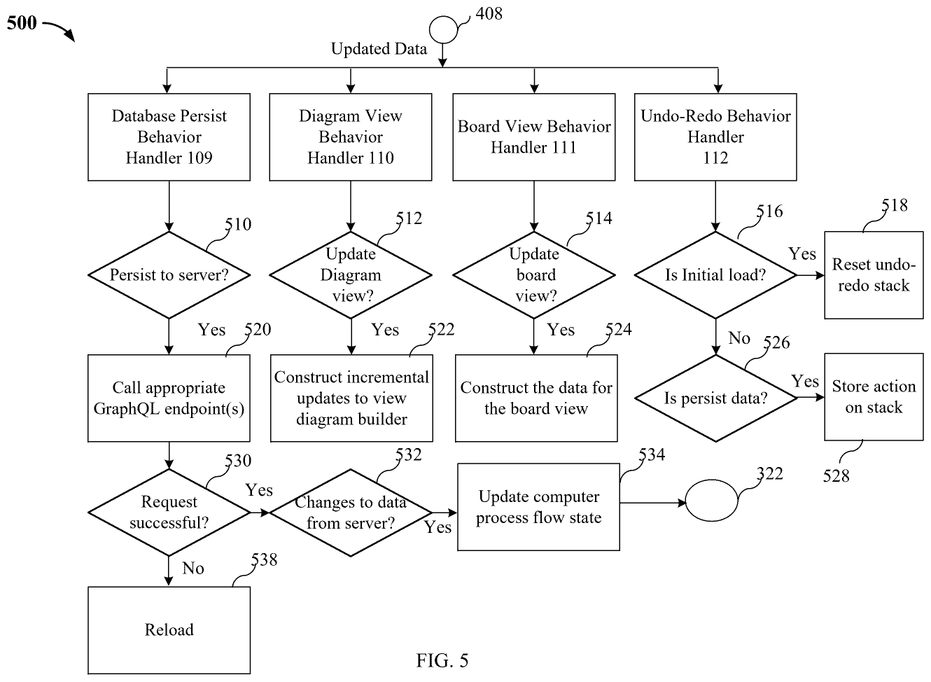

FIG. 5 illustrates an exemplary computer process flow state changes handling layer 500. In some embodiments, computer process flow state changes handling layer 500 is at least a part of computer process flow state changes handling layer 108 in FIG. 1, and computer process flow state changes handling layer 500 may be used to perform at least part of step 210 of FIG. 2.

At computer process flow state changes handling layer 500, different behavior handlers may listen to the notifications of any applicable changes that are allowed by validation layer 400 to pass through as output at 408. In response to a computer process flow state that has been updated, the different behavior handlers may react to any applicable changes. For example, the UIs may be updated to reflect those changes. The behavior handlers may include database persist behavior handler 109, diagram view behavior handler 110, board view behavior handler 111, and undo-redo behavior handler 112.

Database persist behavior handler 109 handles the persisting of any state changes that need to be saved to the server. At step 510, it is determined whether the state change should be persisted to the database. If yes, then requests to the server are sent at step 520. For example, requests to a GraphQL server may be sent. GraphQL is a query language and runtime for application programming interfaces (APIs). At step 530, it is determined whether the request is successful. If the request fails, then a reload is performed at step 538. If the request is successful, then, at step 532, it is determined whether the database server has initiated any data change actions. If there are data changes initiated by the database server, then the computer process flow state is updated at step 534, and then process 500 proceeds back to 322 and step 402 of FIG. 4, such that the updated data and the new computer process flow state may be validated by validation layer 400.

Diagram view behavior handler 110 performs incremental updates to the diagram view for any state changes that may be applied to the diagram view, e.g., adding or updating an activity or a lane of the process. In particular, at step 512, it is determined whether the diagram view should be updated based on the state changes. If yes, then incremental updates are constructed and sent to the diagram builder at step 522.

Board view behavior handler 111 updates the board view for any state changes that may be applied to the board view, e.g., adding or updating an activity or a lane of the process. In particular, at step 514, it is determined whether the board view should be updated based on the state changes. If yes, then the data for the board view is constructed at step 524.

Undo-redo behavior handler 112 tracks the changes/actions on the computer process flow state for undo/redo. In particular, at step 516, it is determined whether it is an initial load. If yes, then the undo-redo stack is reset at step 518. If not, then it is determined whether the data is persisted data at step 526. If yes, then the changes/actions are stored on the undo-redo stack at step 528.

With reference to FIG. 4 again, validation layer 400 provides users with real-time validation to expedite efficient resolution of process errors at design time. In some other traditional workflow management and automation tools, a user may be allowed to activate a process even though the process contains certain errors and the user is only shown an error alert once it is sent from the server. Therefore, improved techniques that can provide additional layers of details to guide users to error resolution and bring real-time feedback for fixing errors proactively before activation would be desirable. Validation layer 400 enables the multiple views (e.g., the board view, the diagram view, and the side panel view) to provide a unified representation of errors across all components of the process. It provides context to pinpoint exactly what items and their fields are problematic so that users can resolve them with ease. In addition, validation layer 400 enables a consistent pluggable system where new validators may be plugged into the client data lifecycle in order to automatically validate any change in the designer.

In some embodiments, validation errors and warnings may be managed consistently and exposed to the users in various features:
Real-time calculation of errors and warnings may be performed at any time a change is made in PAD.
Error and warning UI elements may be presented for stage and activity levels in the board view, the diagram view, and the side panel.
Process activation button may be disabled when errors are present.
Errors and warnings may be displayed in the error trays next to the activation buttons, with links to the side panel for relevant items.
The side panel may show error badges under individual fields to denote exactly what field has an error.
The warnings that do not affect process runtime may be automatically cleaned up for the user.
Error notifications for identifying problems in PAD are provided.
Conflicts caused by multiple users editing the same process may be prevented.
Initial load server validation errors and subsequent client validation errors are seamlessly merged.
New server errors are transformed to client-side formats.

However, validation layer 400 is not limited to the above exemplary features only. The validation techniques allow for easy extensions to account for a wide variety of use cases. The above feature set may be built into the no-code workflow builder and does not require any configurations.

Validation layer 400 includes a set of validators. The set of checks that are run by the client-side validators may include:
A mandatory field must have a value. If a field is required then it must be filled in to activate the process. For example, because stage and activity labels are used for the corresponding record, they can never be cleared out and they must always be saved with a value.
All references in a process should be valid and correct at design time.
Process definitions do not allow start rule loops, and the creation of any loops is prevented. For example, if a user attempts to create a loop in the start rules by dragging an edge from one item to the incoming connection of another item that starts before it, then a start rule loop is detected.
Redundant edges or paths are removed. A redundant path is a path between two items where one path is direct and another goes through child dependencies. The shorter path is not needed since there is a longer dependency chain. The redundant path may be highlighted as a warning and automatically removed upon process activation to keep the diagram clean and simple.
All start rules must be applied at or immediately after a specific stage or activity to keep the diagram consistent. For example, the start rules for “After Stages” or “After Activities” must not be empty.
Outgoing connections must be valid. All items must connect to another item or the end diagram node to keep the diagram consistent for users. For example, a warning is given when an outgoing connection is not connected to its end node.
   In some embodiments, the above checks may be performed for both the stages and the activities. The checks may be performed for any incremental updates.

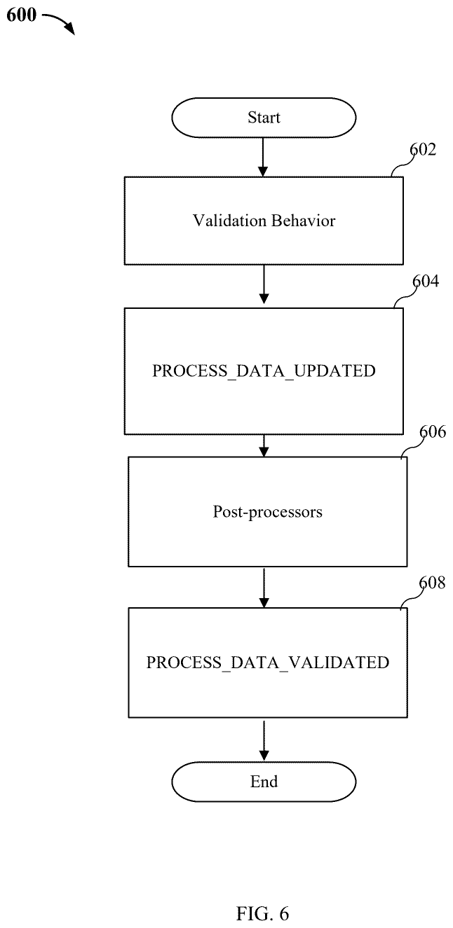

FIG. 6 illustrates another exemplary validation layer 600. In some embodiments, validation layer 600 is at least a part of validation layer 104 in FIG. 1 or validation layer 400 in FIG. 4, and validation layer 600 may be used to perform at least part of step 206 of FIG. 2.

Validation layer 600 includes a validation behavior module 602. A data structure “create ValidateProcessData” may be used to accept an array of validators as well as a list of post-processors. In some embodiments, each validator may be stored in its respective validator utility (util) file in a validator-utils directory, and each post-processor may be stored in its respective post-processor util file in the same directory. The validators and post-processors may be provided in an index.js file.

The client-side may be implemented as a set of separate utils that can be run in sequence to dynamically build a set of errors. These utils may include a factory function or multiple functions composed together that are provided to the validation behavior 602. They accept and return a common format. They may identify what things are relevant to them, add new errors, and remove their own errors for things that have been resolved. This allows for an easy extension and optimization. The list of validators composed and provided to the validation behavior module 602 can be found in a behaviors/validation/index.js file with each validator's respective utils nested under the validator-utils directory.

Validation layer 600 includes a PROCESS_DATA_UPDATED module 604. When a set of updates is made in the diagram, board, or side panel, the requested updates are passed to the validation layer via a structure PAD_UPDATE PROCESS_DATA. Each validator is run in sequence, passing the results of the previous execution into the next. The latest errors and the actions that need to be performed are collected.

Validation layer 600 includes a post-processors module 606. The post-processors are executed. Post-processors examine the error results and the actions that need to be performed that have been collected during the current iteration of the validation and determine if some other action needs to be taken before allowing the update to be passed along to be stored in computer process flow state and to trigger other behaviors to react to the update. Post-processors determine if the current validation cycle needs to stop executing. Post-processors determine if a separate action needs to be dispatched, such as presenting a modal for confirmation, before continuing. Post-processors determine if the current errors and payload need to be staged for later use.

Validation layer 600 includes a PROCESS_DATA_VALIDATED module 608. Once the validators and post-processors have been run, PAD_PROCESS_DATA_VALIDATED is called and the latest validation error objects are saved.

PAD_PROCESS_DATA_VALIDATED is received by the process-state behavior module in computer process flow state layer 106 (see FIG. 1), which saves the new process data in the computer process flow state and enables other behaviors to react to the updates (such as persisting the change). In addition to the latest aggregated errors, the new and cleared error objects are also sent along as an optimization, such that the other behaviors may respond to only errors that are relevant to them. These error objects are calculated dynamically and passed along, thereby enabling quick lookup of the latest new errors and cleared errors. The latest aggregated errors object is returned as part of the updateProperties callback to save the validation errors. If the state of the errors has in fact changed, then an update is performed.

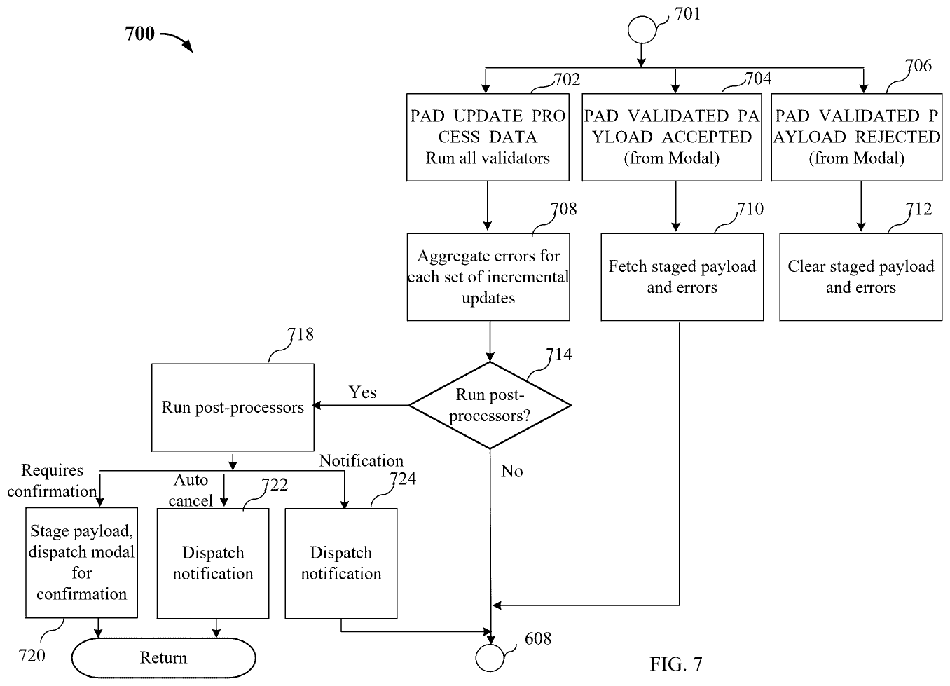

FIG. 7 illustrates an exemplary validation process 700. In some embodiments, validation process 700 may be performed by PROCESS_DATA_UPDATED module 604 and post-processors module 606 in FIG. 6.

At step 701, the output of validation behavior module 602 is received. At step 702, when a set of updates is made in the diagram, board, or side panel, the requested updates are passed to the validation layer via a structure PAD_UPDATE PROCESS DATA. Each validator is executed in sequence. At step 708, the errors for each set of incremental updates are aggregated.

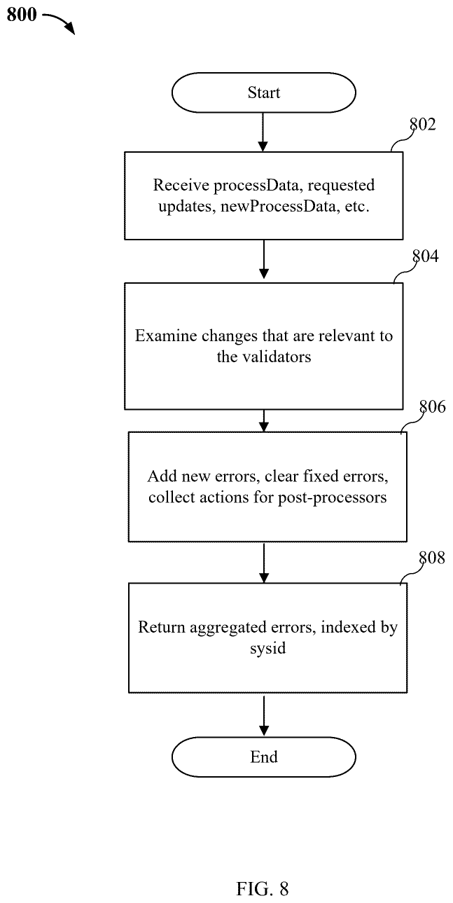

FIG. 8 illustrates an exemplary process 800 for executing the validators. In some embodiments, process 800 is performed at step 702 of FIG. 7. At step 802, processData, requested updates, and newProcessData are received. At step 804, the changes that are relevant to the validators are examined. At step 806, new errors are added, fixed errors are cleared, and actions for the post-processors are collected. At step 808, the aggregated errors are returned, which are indexed by sysid.

Referring back to FIG. 7, at step 714, it is determined whether the post-processors should be executed. If the decision at step 714 is NO, then control is passed to PROCESS DATA_VALIDATED module 608 in FIG. 6. If the decision at step 714 is Yes, then the post-processors are executed at step 718. When a confirmation is required, at step 720, a payload is staged and a modal for confirmation is dispatched. When there is an auto cancellation, a notification is dispatched at step 722. When a notification is needed, a notification is dispatched at step 724, and control is passed to PROCESS_DATA_VALIDATED module 608 in FIG. 6.

The post-processors may handle the following:
Bulk Stage Deletion: If any stage that is being removed contains any activities, then it is considered as a bulk operation, and the user is presented with a confirmation modal before proceeding.
Cancel With Notification: Cancelling an execution with a notification will result in the update being discarded and the provided alert to be displayed to the user.
Requires Confirmation: An action that requires a user confirmation will stage the update payload along with any errors that will be created by the update and present a confirmation modal to notify the user about the errors.
The post-processors include an array, and the validators can add to the list the things that are relevant to the validators. The methods to handle different error cases may be decoupled from the types of errors.

At step 704, PAD_VALIDATED_PAYLOAD is accepted. At step 710, the staged payload and errors are fetched. At step 706, PAD_VALIDATED_PAYLOAD is rejected. At step 712, the staged payload and errors are cleared.

For example, if the post-processors come across an action for requiring confirmation, they may dispatch a modal (step 720) to inform the user that they may be breaking some references (thus causing errors) if they proceed with the action and ask the user if the user wants to continue. If the user rejects the change, then the staged data is cleared and the update is not persisted at step 712. If the user accepts the change, then the update is allowed to pass through and the staged data is fetched and passed along at step 710. There is no need to re-run the validators again since they have already been run and the data has been saved for easy fetching.

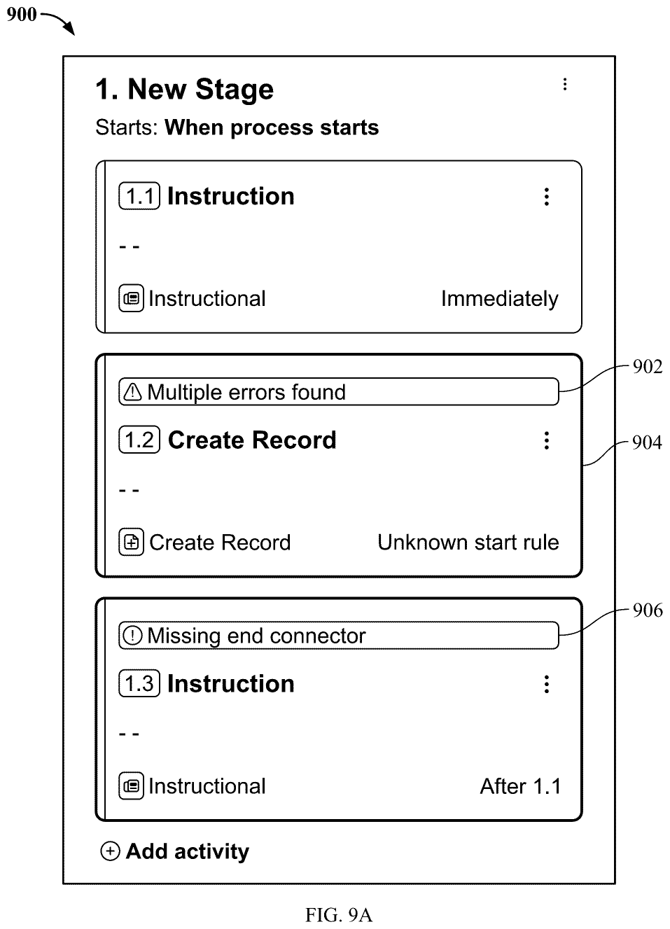

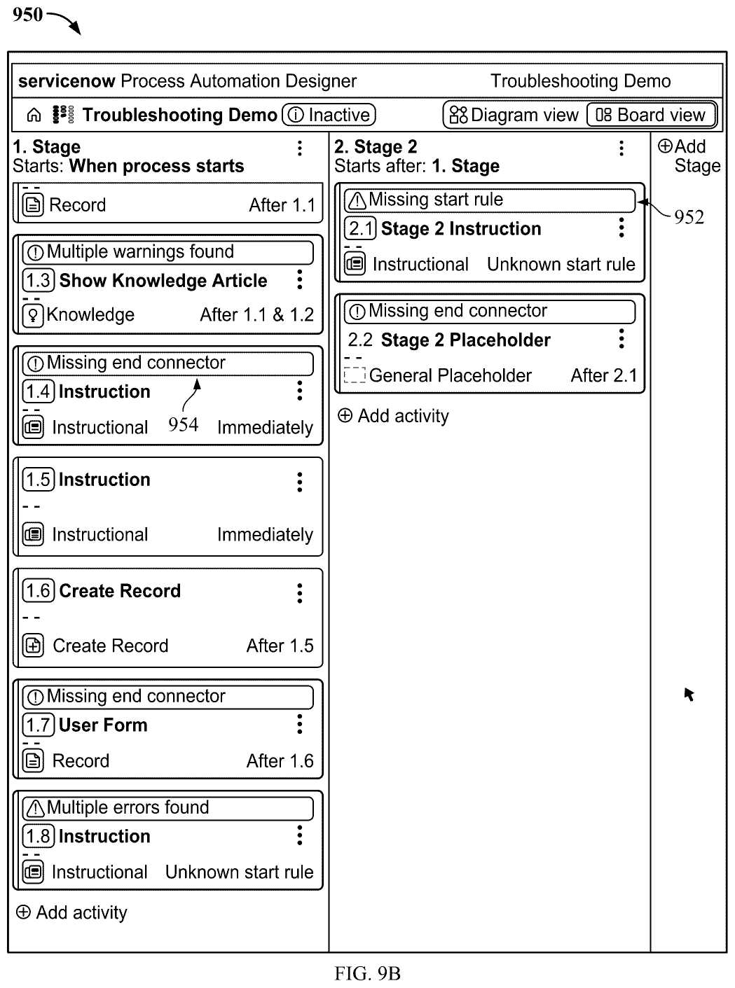

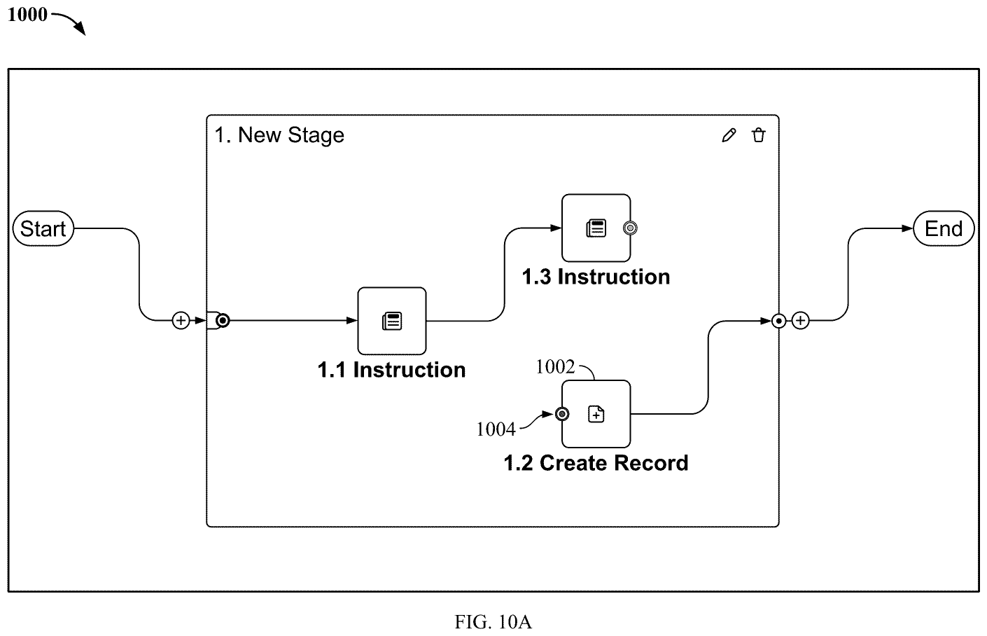

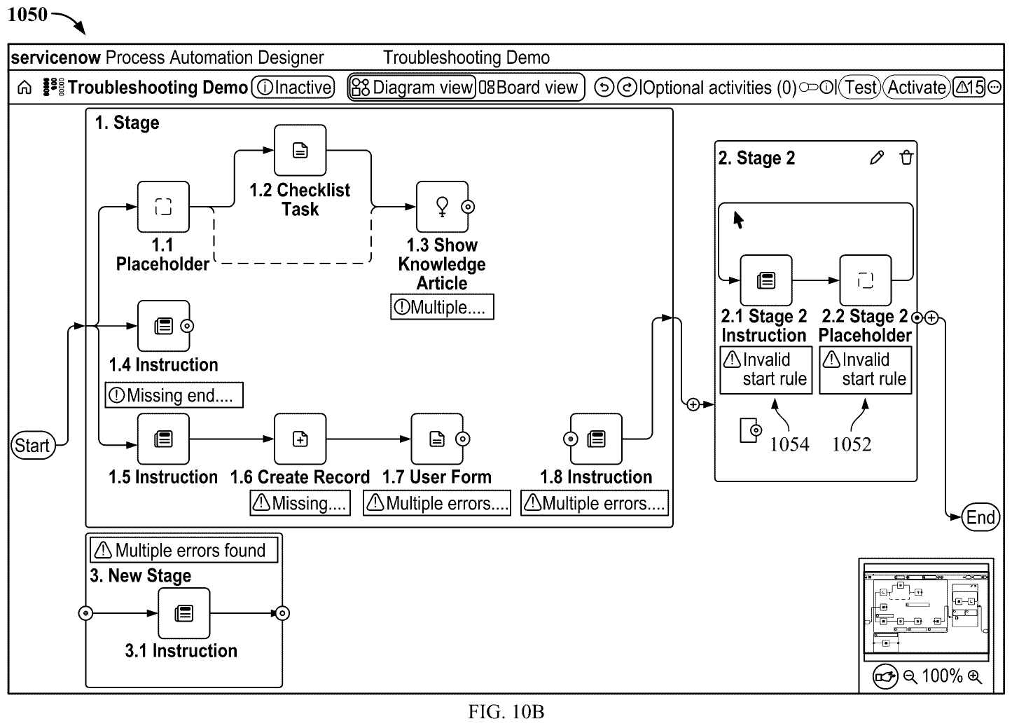

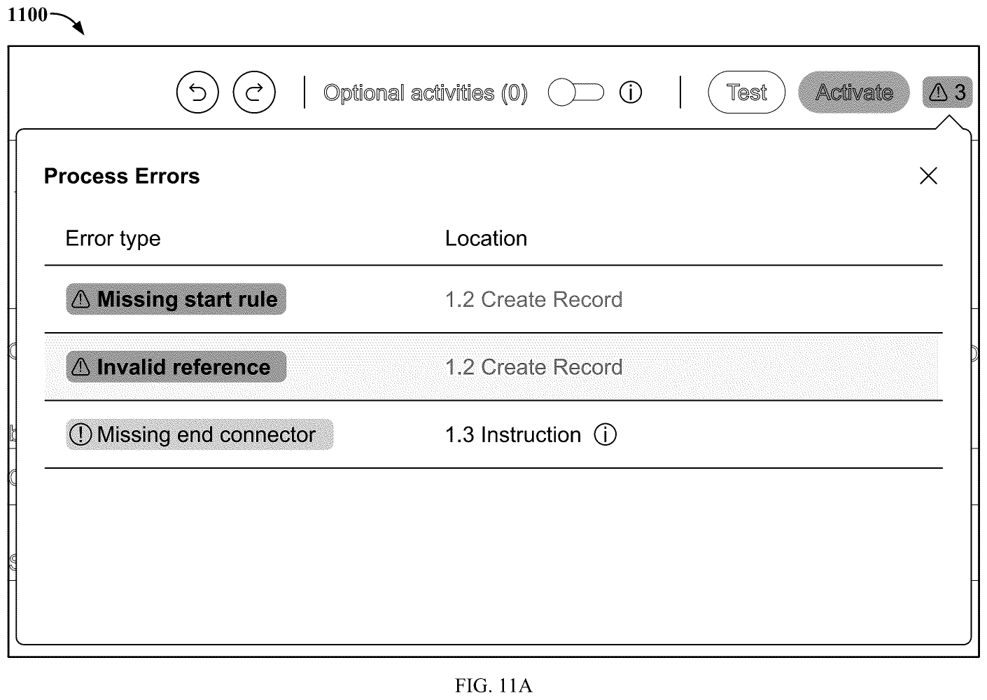

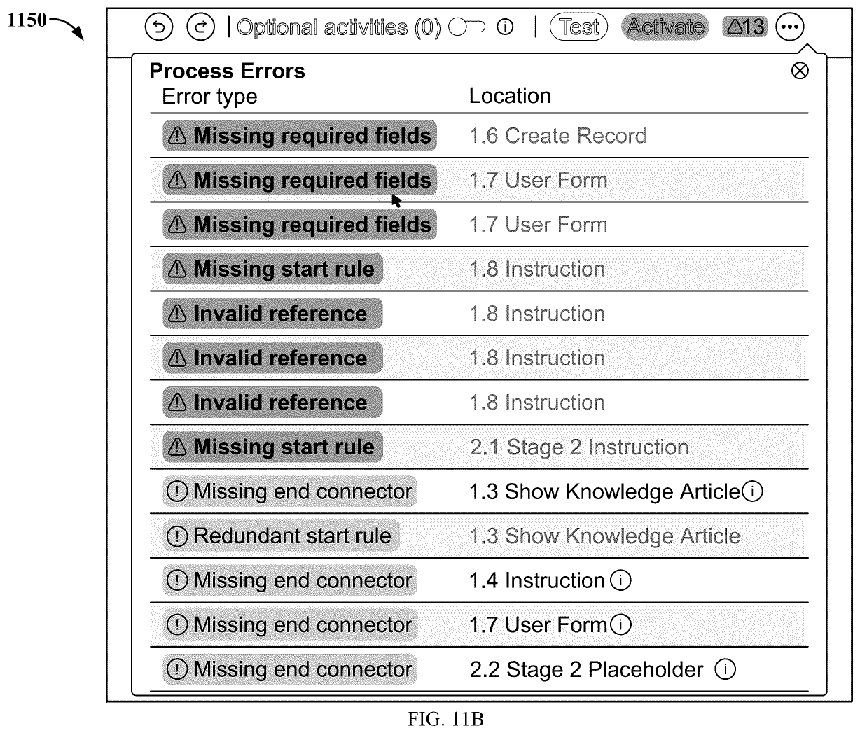

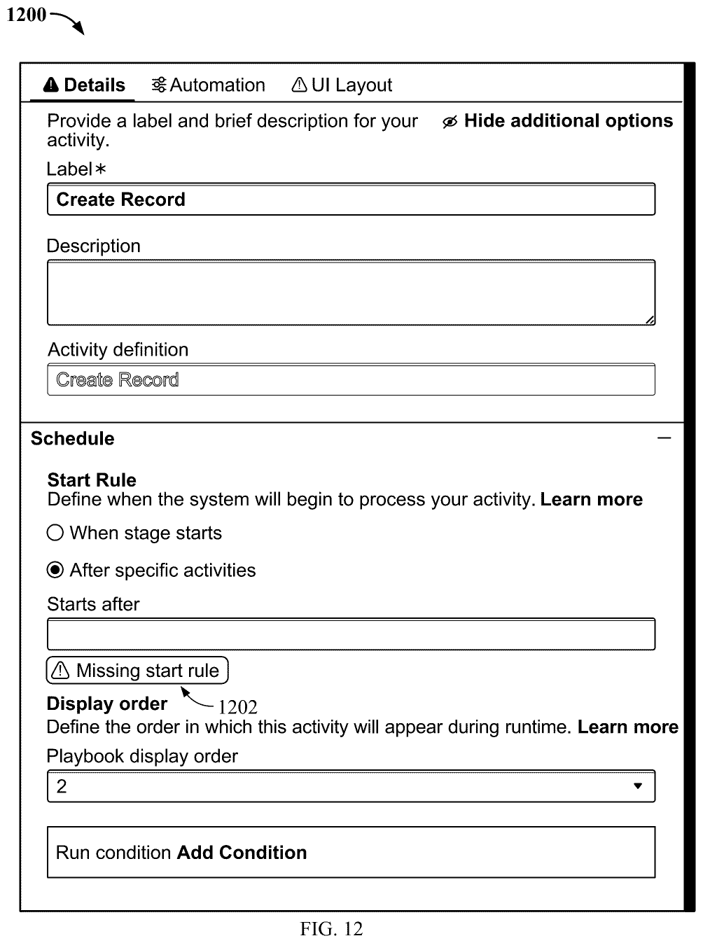

Validation errors of a process may be shown in different views. FIG. 9A illustrates that validation errors are populated in a board view 900. Board view 900 shows a notification 902 of “Multiple errors found” in a “create record” activity 904. Board view 900 also shows a notification 906 of “Missing end connector.” FIG. 9B illustrates an example board view 900 with a number of validation errors. Board view 950 shows a notification 952 of “Missing start rule” and a notification 954 of “Missing end connector.” FIG. 10A illustrates that the validation errors are populated in a diagram view 1000. A “create record” activity 1002 that is missing an end connector is indicated as a red circle 1004 in diagram view 1000. FIG. 10B illustrates an example diagram view 1050 with a number of validation errors. Diagram view 1050 shows a first notification 1052 of “Invalid start rule” and a second notification 1054 of “Invalid start rule.” FIG. 11A illustrates that the validation errors are populated in an error tray 1100. FIG. 11B illustrates another example error tray 1150 with a number of validation errors. FIG. 12 illustrates that the validation errors are populated in a side panel 1200. A notification 1202 for “Missing start rule” is shown in side panel 1200.

The process data is maintained by the data manager. When a change on an item is requested in the designer, a set of incremental updates is constructed to insert, update, or remove data. In some embodiments, as an optimization of the client-side logic, the set of incremental changes may be parsed and acted upon by the validator associated with those changes, thereby eliminating the need to check the fields for every stage and every activity in a process every time a change is made in the designer. In other words, a portion of the computer process flow that is affected by the data change action is determined and validation is only performed on that portion of the computer process.

For example, if a user fails to specify the start rule of a single activity, only the one activity needs to be checked and have an error saved for a missing start rule. If there are 10 lanes, each with 10 activities, and a user tries to drag an edge between 2 activities in one of the lanes, then only the activities in that lane need to be checked to ensure a loop is not created or if a redundant edge is created. There is no need to check every activity in every lane because they are not affected. Changing the value of a mandatory field does not affect start rules, and therefore loop/redundant edge detection and reference validation may be skipped. Since an incremental change is limited to a subset of the whole process (e.g., just a single item) and the things that the validators care about do not always overlap, parsing the incremental update allows for a more granular look at the changes being made and more control in running only checks that are necessary.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving an indication of a user interaction with a user interface element of a user interface, wherein the user interface enables generation of a computer process flow;
identifying a data change action associated with the user interaction;
based on the data change action, updating a computer process flow state associated with the computer process flow to reflect the data change action; and
in response to the computer process flow state being updated to reflect the data change action, triggering one or more behaviors based on the data change action.

2. The method of claim 1, wherein the user interface element comprises one or more of the following: an activity in the computer process flow, a vertical lane that comprises a plurality of activities in a sequence, a horizontal swimlane, an undo button for undoing a previous user interaction with a previous user interface element, or a redo button for repeating a previous user interaction with a previous user interface element.

3. The method of claim 1, wherein the user interface is one of a plurality of user interfaces to build the computer process flow, wherein the plurality of user interfaces corresponds to a plurality of views of the computer process flow.

4. The method of claim 3, wherein the plurality of views of the computer process flow comprises one or more of the following: a board view, a diagram view, a side panel, or an error tray.

5. The method of claim 1, wherein the computer process flow state corresponds to a centralized single source of truth of the computer process flow, wherein the computer process flow state is stored in a local memory.

6. The method of claim 1, further comprising:
validating the data change action; and
based on the validating of the data change action, updating the computer process flow state associated with the computer process flow to reflect the data change action.

7. The method of claim 6, further comprising:
providing an interface for a plurality of behavior handlers to subscribe to update notifications of the computer process flow state; and
triggering the one or more behaviors based on the data change action via the plurality of behavior handlers.

8. The method of claim 7, wherein one of the plurality of behavior handlers comprises a database persist behavior handler for persisting the computer process flow state in a database server.

9. The method of claim 8, further comprising:
determining whether the database server has initiated a second data change action in response to the persisted computer process flow state in the database server;
validating the second data change action;
based on the validating of the second data change action, updating a second computer process flow state associated with the computer process flow to reflect the second data change action; and
in response to the second computer process flow state being updated to reflect the second data change action, triggering one or more behaviors based on the second data change action.

10. The method of claim 7, wherein one of the plurality of behavior handlers comprises a diagram view behavior handler corresponding to a diagram view of the computer process flow, wherein the diagram view behavior handler is configured to perform incremental updates to the diagram view based on the data change action.

11. The method of claim 7, wherein one of the plurality of behavior handlers comprises a board view behavior handler corresponding to a board view of the computer process flow, wherein the board view behavior handler is configured to perform incremental updates to the board view based on the data change action.

12. The method of claim 7, wherein one of the plurality of behavior handlers comprises an undo-redo behavior handler for undoing a previous user interaction with a previous user interface element or redoing the previous user interaction with the previous user interface element.

13. The method of claim 6, wherein the validating of the data change action comprises:
determining whether the data change action should be blocked; and
in response to determining that the data change action should be blocked, blocking the data change action and providing a blocking modal.

14. The method of claim 6, wherein the validating of the data change action comprises one or more of the following: validating that a mandatory field has an assigned value, validating that a reference in the computer process flow is valid, validating that the computer process flow does not include a start rule loop, validating that there are no redundant edges or paths in the computer process flow, validating that a start rule is not empty, or validating that an outgoing connection is valid.

15. The method of claim 6, wherein the validating of the data change action comprises:
identifying a portion of the computer process flow that is affected by the data change action and selectively validating the identified portion of the computer process flow.

16. A system, comprising:
a processor configured to:
receive an indication of a user interaction with a user interface element of a user interface, wherein the user interface enables generation of a computer process flow;
identify a data change action associated with the user interaction;
based on the data change action, update a computer process flow state associated with the computer process flow to reflect the data change action; and
in response to the computer process flow state being updated to reflect the data change action, trigger one or more behaviors based on the data change action; and
a memory coupled to the processor and configured to provide the processor with instructions.

17. The system of claim 16, wherein the computer process flow state corresponds to a centralized single source of truth of the computer process flow, wherein the computer process flow state is stored in a local memory.

18. The system of claim 16, wherein the processor is configured to:
provide an interface for a plurality of behavior handlers to subscribe to update notifications of the computer process flow state; and
trigger the one or more behaviors based on the data change action via the plurality of behavior handlers.

19. The system of claim 18, wherein one of the plurality of behavior handlers comprises a database persist behavior handler for persisting the computer process flow state in a database server.

20. The system of claim 16, wherein the processor is configured to:
determine whether the data change action should be blocked; and
in response to determining that the data change action should be blocked, block the data change action and provide a blocking modal.

21. A computer program product embodied in a non-transitory computer readable medium and comprising computer instructions for:
receiving an indication of a user interaction with a user interface element of a user interface, wherein the user interface enables generation of a computer process flow;
identifying a data change action associated with the user interaction;
based on the data change action, updating a computer process flow state associated with the computer process flow to reflect the data change action; and
in response to the computer process flow state being updated to reflect the data change action, triggering one or more behaviors based on the data change action.
